(19) United States
(12) Patent Application Publication
(10) Pub. No.: US 2023/0351189 A1
(43) Pub. Date: Nov. 2, 2023

(54) METHOD OF TRAINING BINARIZED NEURAL NETWORK WITH PARAMETERIZED WEIGHT CLIPPING AND MEMORY DEVICE USING THE SAME

(71) Applicant: Samsung Electronics Co., Ltd., Suwon-si (KR)

(72) Inventors: Taehee Han, Seoul (KR); Juyeon Kang, Suwon-si (KR); Changho Ryu, Suwon-si (KR)

(73) Assignee: RESEARCH & BUSINESS FOUNDATION SUNGKYUNKWAN UNIVERSITY, Suwon-si (KR)

(21) Appl. No.: 18/171,433

(22) Filed: Feb. 20, 2023

(30) Foreign Application Priority Data
Apr. 27, 2022 (KR) 10-2022-0051970
Jun. 17, 2022 (KR) 10-2022-0073902

(51) Int. Cl. G06N 3/084; G06N 3/0464

(52) U.S. Cl. CPC G06N 3/084; G06N 3/0464

(57) ABSTRACT

In a method of training a binarized neural network (BNN), a binarized weight set is generated by applying a clipping function to a weight set. Output data is generated by sequentially performing a forward computation on the binarized neural network based on input data and the binarized weight set. A gradient of the weight set is generated by sequentially performing a backward computation on the binarized neural network based on loss calculated from the output data. The binarized neural network is trained by updating the weight set based on the gradient of the weight set and changing a range of the clipping function.

### CROSS-REFERENCE TO RELATED APPLICATION

This application claims priority under 35 USC § 119 to Korean Patent Application No. 10-2022-0051970 filed on Apr. 27, 2022, and to Korean Patent Application No. 10-2022-0073902 filed on Jun. 17, 2022, in the Korean Intellectual Property Office (KIPO), the contents of which are herein incorporated by reference in their entirety.

### BACKGROUND

### 1. Technical Field

Example embodiments relate generally to semiconductor integrated circuits, and more particularly to methods of training binarized neural networks with parameterized weight clipping, and memory devices using the methods of training the binarized neural networks.

### 2. Description of the Related Art

Over the past decade, artificial neural network-based deep learning technology has been applied to a variety of different fields. However, as the networks are becoming deeper and broader, computational costs can become increasingly significant. For example, a representative autoregressive language model, generative pre-trained transformer (GPT)-3, increases the number of parameters to 175 billion, thereby significantly amplifying the computational burden. A variety of studies on neural network compression have been presented with minimal performance degradation to address the computational cost concern.

By aggressively reducing the parameters to a data width of 1-bit at the expense of considerable accuracy loss, a binarized neural network (BNN) demonstrates significant benefits in memory footprint and computational speed. Various studies have addressed the accuracy loss of BNNs, such as XNORNet, Bi-real, etc. Nonetheless, improving BNN performance through parameter processing or modulation may be limited.

### SUMMARY

At least one example embodiment of the present disclosure provides a method of training a binarized neural network (BNN) using a parameterized weight clipping (PWC) scheme, which may improve accuracy of the BNN.

At least one example embodiment of the present disclosure provides a memory device implemented on which the binarized neural network may be trained using the PWC scheme and on which the BNN may operate in inference mode.

According to example embodiments, in a method of training a binarized neural network (BNN), a binarized weight set is generated by applying a clipping function to a weight set. Output data is generated by sequentially performing a forward computation on the binarized neural network based on input data and the binarized weight set. A gradient of the weight set is generated by sequentially performing a backward computation on the binarized neural network based on loss calculated from the output data. The binarized neural network is trained by updating the weight set based on the gradient of the weight set and changing a range of the clipping function.

According to example embodiments, a memory device includes a memory core including a plurality of memory cells and comprising data embodied in the memory cells that is executable by the processing logic to perform operations comprising: generating a binarized weight set by applying a clipping function to a weight set, generating output data by sequentially performing a forward computation on the binarized neural network based on input data and the binarized weight set, generating a gradient of the weight set by sequentially performing a backward computation on the binarized neural network based on loss calculated from the output data, and training a binarized neural network (BNN) comprising updating the weight set based on the gradient of the weight set; and changing a range of the clipping function.

According to example embodiments, in a method of training a binarized neural network (BNN), a clipped weight set is obtained by applying a clipping function to a weight set. A binarized weight set is obtained by applying a scaled sign function to the clipped weight set. Output data is generated by sequentially performing a forward computation on the binarized neural network based on input data and the binarized weight set. A gradient of the weight set, a gradient of a first threshold value of the clipping function and a gradient of a second threshold value of the clipping function are generated by sequentially performing a backward computation on the binarized neural network based on loss calculated from the output data. The weight set is updated based on the gradient of the weight set. The first threshold value of the clipping function is updated based on the gradient of the first threshold value of the clipping function. The second threshold value of the clipping function is updated based on the gradient of the second threshold value of the clipping function. The binarized neural network is a binarized convolutional neural network (BCNN). The forward computation is performed in an order of a convolution operation, a pooling operation, a batch normalization and an activation function. The backward computation is performed in an order of the activation function, the batch normalization, the pooling operation, the convolution operation, the scaled sign function, and the clipping function. A range of the clipping function is adaptively changed based on a magnitude of the weight set. The range of the clipping function is changed using the gradient of the first threshold value of the clipping function and the gradient of the second threshold value of the clipping function.

In the method of training the binarized neural network and the memory device according to example embodiments, when the binarized neural network is trained, the weight set may be updated, and the parameterized weight clipping scheme in which the range of the clipping function applied to the weight set is adaptively and dynamically changed may be used. For example, the range of the clipping function may be changed based on gradient descent in the backpropagation process. Accordingly, a problem caused by gradient mismatch (or missing) in the binarized neural network, e.g., a dead weight problem, may be reduced, the binarized neural network may be efficiently trained with a reduced or minimum decrease in accuracy, and the accuracy of the binarized neural network may be improved or enhanced as compared to a conventional training scheme.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of training a binarized neural network (BNN) according to example embodiments.

FIG. 2 is a flowchart illustrating an example of a method of training a binarized neural network of FIG. 1 according to example embodiments.

FIGS. 3 and 4 are block diagrams illustrating a binarized neural network training device according to example embodiments.

FIGS. 5A, 5B and 5C are diagrams illustrating examples of a neural network model that is a target of a method of training a binarized neural network according to example embodiments.

FIG. 6 is a block diagram illustrating an example of a binarized neural network training device for training a binarized convolutional neural network according to example embodiments.

FIG. 7 is a flowchart illustrating an example of generating a binarized weight set in FIG. 2 according to example embodiments.

FIG. 8 is a flowchart illustrating an example of generating output data in FIG. 2 according to example embodiments.

FIG. 9 is a flowchart illustrating an example of generating a gradient of a weight set in FIG. 2 according to example embodiments.

FIG. 10 is a flowchart illustrating an example of performing a training operation in FIG. 2 according to example embodiments.

FIG. 11 is a flowchart illustrating an example of a method of training a binarized neural network of FIG. 1 according to example embodiments.

FIGS. 12 and 13 are flowcharts illustrating examples of storing a result of a training operation in FIG. 11 according to example embodiments.

FIG. 14 is a block diagram illustrating a binarized neural network executing device according to example embodiments.

FIGS. 15 and 16 are block diagrams illustrating examples of a binarized neural network executing device that is configured to execute a binarized convolutional neural network according to example embodiments.

FIG. 17 is a block diagram illustrating a memory device and a memory system including the memory device according to example embodiments.

FIG. 18 is a block diagram illustrating an example of a memory device in FIG. 17 according to example embodiments.

FIG. 19 is a block diagram illustrating a memory device and a memory system including the memory device according to example embodiments.

FIGS. 20A, 20B, 20C and 20D are diagrams for describing performance of a method of training a binarized neural network according to example embodiments.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination.

Embodiments of the inventive concept are described herein in the context of an Artificial Intelligence (AI) system, which uses multi-layer neural network technology. Moreover, it will be understood that the multi-layer neural network is a multi-layer artificial neural network comprising artificial neurons or nodes and does not include a biological neural network comprising real biological neurons. The multi-layer neural network described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the AI training process to improve the efficiency of a computer system when the computer system operates in an inference mode to make an inference, prediction, classification, suggestion, or the like.

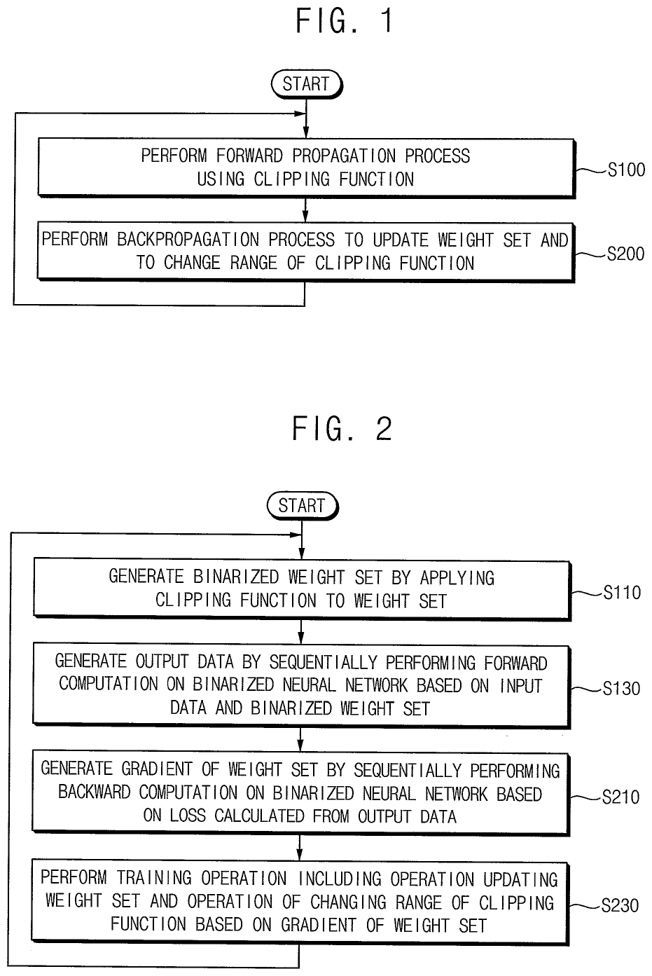

FIG. 1 is a flowchart illustrating a method of training a binarized neural network (BNN) according to example embodiments.

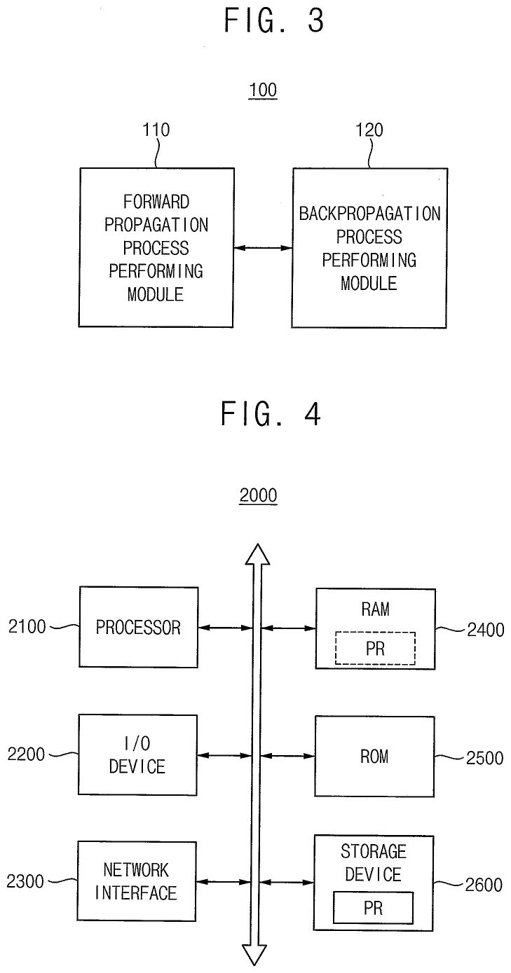

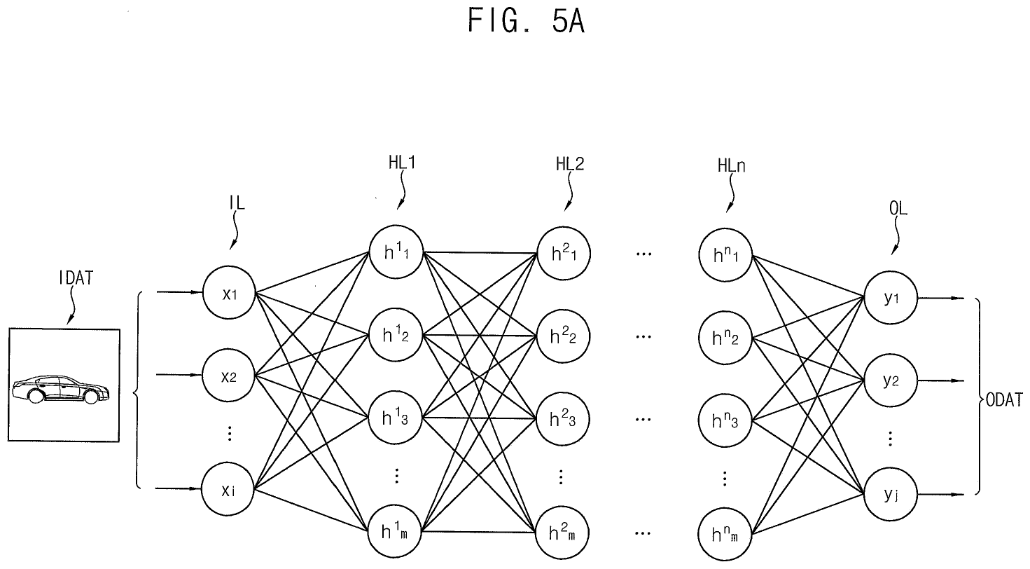

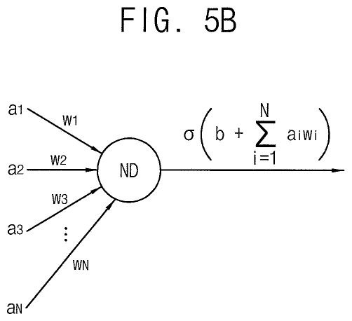

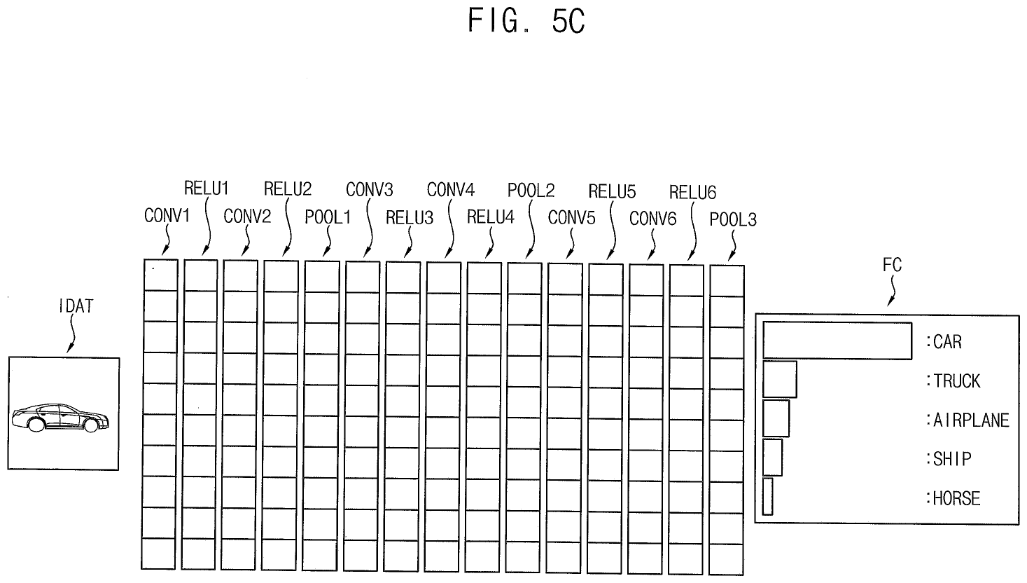

Referring to FIG. 1, a method of training a binarized neural network according to example embodiments may be performed by a binarized neural network training device. A configuration of the binarized neural network training device will be described with reference to FIGS. 3 and 4, and a binarized neural network (or neural network) that is a target of training will be described with reference to FIGS. 5A, 5B and 5C.

In the method of training the binarized neural network according to example embodiments, a forward propagation process is performed on the binarized neural network using a clipping function (block S100).

There are various methods of classifying data based on machine learning. Among them, a method of classifying data using a neural network or an artificial neural network (ANN) is one example. The neural network is obtained by engineering a cell structure model of a human brain where a process of efficiently recognizing a pattern is performed. The neural network refers to a calculation model that is based on software or hardware and is designed to imitate biological calculation abilities by applying many artificial neurons interconnected through connection lines. The human brain consists of neurons that are basic units of a nerve, and encrypts or decrypts information according to different types of dense connections between these neurons. Artificial neurons in the neural network are obtained through simplification of biological neuron functionality. The neural network performs a cognition or learning process by interconnecting the artificial neurons having connection intensities.

As will be described with reference to FIGS. 5A, 5B and 5C, the neural network may include a plurality of layers, and outputs may be generated from each layer by performing computations or calculations based on inputs to each layer and weights applied to the inputs in each layer. The binarized neural network may be a neural network in which binarized weights may take values of 1 or −1 and are represented or expressed by a single bit, and thus the amount of computation and memory requirements may be reduced.

The clipping function may represent a function that, when a magnitude (or amplitude) of a specific weight is out of a predetermined range, changes the corresponding weight to a predetermined threshold value corresponding to the predetermined range. The efficient training may be performed by applying, employing, or using the clipping function when the binarized neural network is trained. For example, the clipping function may be applied to a weight set that includes a plurality of weights (or weight elements).

The forward propagation process may be a portion of procedures performed while the binarized neural network is trained. The forward propagation process may represent a process of calculating output data by passing input data through the binarized neural network in a forward direction.

Thereafter, a backpropagation process is performed to update the weight set and to change a range of the clipping function (block S200).

The backpropagation process may be another portion of procedures performed while the binarized neural network is trained. The backpropagation process may represent a process of calculating loss by comparing the output data with a label, which is ground truth obtained in advance, and a process of calculating a gradient for the weights, such that the loss is reduced by passing the calculated loss through the binarized neural network in a reverse direction.

Blocks S100 and S200 may be alternately and repeatedly performed. For example, an operation of sequentially performing blocks S100 and S200 once may be defined as one iteration or one loop, and the binarized neural network may be trained by performing the iteration multiple times.

When blocks S100 and S200 are repeatedly performed, the weight set that is used to perform the computations by the binarized neural network may be updated, and the range of the clipping function that is applied to the weight set may be adaptively and dynamically changed.

FIG. 2 is a flowchart illustrating an example of a method of training a binarized neural network of FIG. 1. The descriptions of operations described previously with respect to FIG. 1 will be omitted.

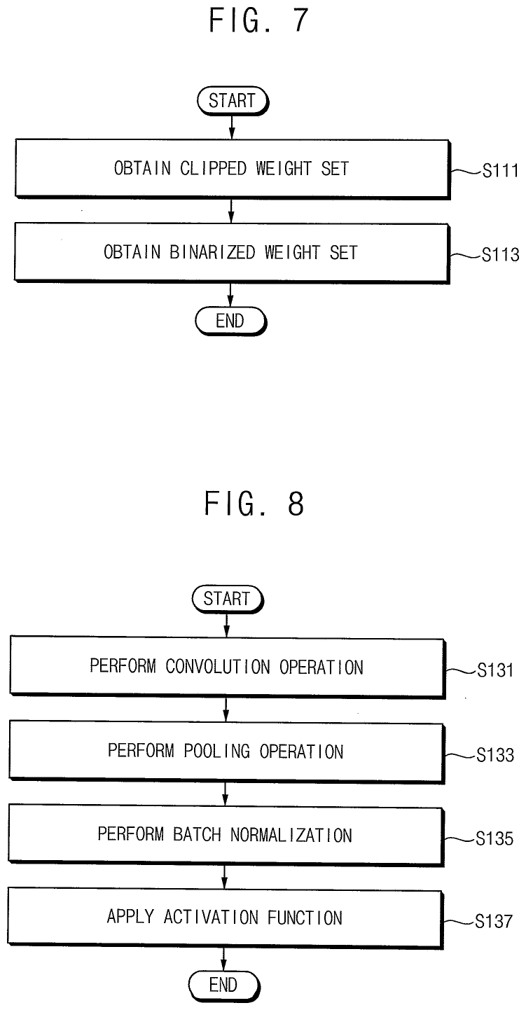

Referring to FIGS. 1 and 2, when performing the forward propagation process on the binarized neural network using the clipping function (block S100), a binarized weight set is generated by applying the clipping function to the weight set (block S110), and the output data is generated by sequentially performing a forward computation on the binarized neural network based on the input data and the binarized weight set (block S130). Block S110 will be described with reference to FIG. 7, and block S130 will be described with reference to FIG. 8.

In some example embodiments, the binarized neural network may be a binarized convolutional neural network (BCNN). For example, a convolutional neural network may be generally used for extracting features of spatial data, and the input data may be image data, etc. However, example embodiments may not be limited thereto.

When the binarized neural network is the binarized convolutional neural network, the operation of sequentially performing the forward computation may represent that a first feature map is generated by performing a first convolutional operation on the input data, a second feature map is generated by performing a second convolutional operation on the first feature map, and the output data is obtained by sequentially performing such convolutional operations.

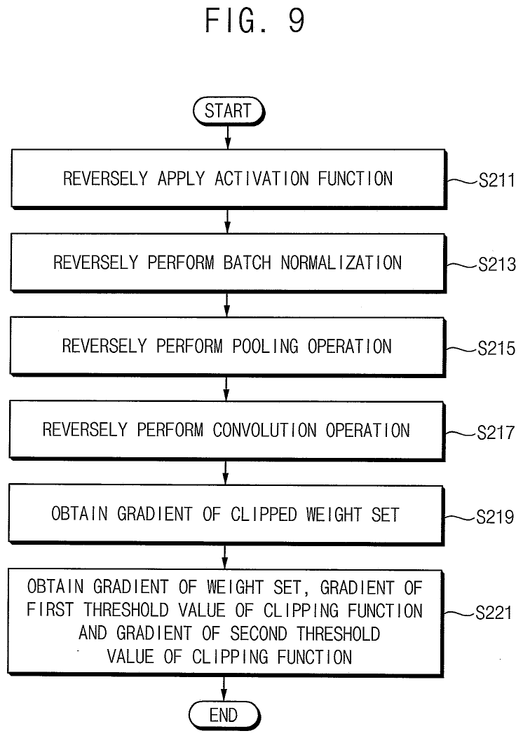

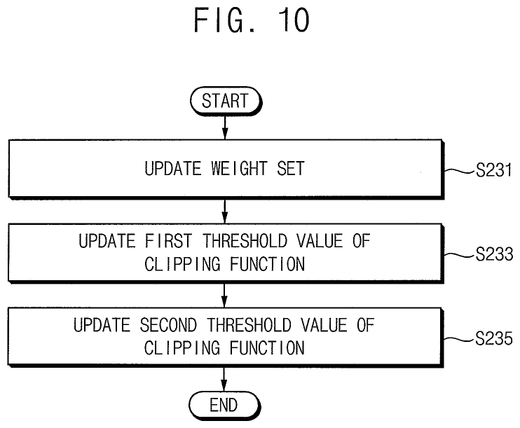

When performing the backpropagation process to update the weight set and to change the range of the clipping function (block S200), a gradient of the weight set is generated by sequentially performing a backward computation on the binarized neural network based on the loss calculated from the output data (block S210), and a training operation, which includes an operation of updating the weight set and an operation of changing the range of the clipping function, is performed based on the gradient of the weight set (block S230). Block S210 will be described with reference to FIG. 9, and block S230 will be described with reference to FIG. 10.

When the binarized neural network is the binarized convolutional neural network, the operation of sequentially performing the backward computation may represent that the series of operations performed in blocks S110 and S130 are performed in a reverse order to the order performed in blocks S110 and S130.

In some example embodiments, the range of the clipping function may be adaptively changed based on a magnitude of the weight set. In other words, to enable the update of as many weight elements as possible, a parameterized clipping function that can be trained based on magnitudes of the weights may be used.

In some example embodiments, the clipping function may include (or may be represented by) a first threshold value and a second threshold value, and the range of the clipping function may be changed using the first threshold value and the second threshold value of the clipping function. For example, the range of the clipping function may be changed using a gradient of the first threshold value of the clipping function and a gradient of the second threshold value of the clipping function. The first threshold value and the second threshold value of the clipping function may be referred to as a lower limit value and an upper limit value of the clipping function, respectively.

In some example embodiments, blocks S110, S130, S210 and S230 may be performed on some or a portion of the binarized neural network. For example, the binarized neural network may include a plurality of layers, and blocks S110, S130, S210 and S230 may be performed on some of the plurality of layers included in the binarized neural network. In other example embodiments, blocks S110, S130, S210 and S230 may be performed on all layers of the binarized neural network.

In some example embodiments, when the binarized neural network is a binarized convolutional neural network, the plurality of layers included in the binarized neural network may include a plurality of convolutional layers. Blocks S110, S130, S210 and S230 may be performed on at least one of the remaining convolutional layers other than a first convolutional layer among the plurality of convolutional layers.

In some example embodiments, when the binarized neural network is a binarized convolutional neural network, the plurality of layers included in the binarized neural network may include at least one fully connected layer. Blocks S110, S130, S210 and S230 may be performed on at least one of the remaining layers other than the fully connected layer among the plurality of layers.

In the method of training the binarized neural network according to example embodiments, when the binarized neural network is trained, the weight set may be updated, and the parameterized weight clipping (PWC) scheme in which the range of the clipping function applied to the weight set is adaptively and dynamically changed may be used. For example, the range of the clipping function may be changed based on gradient descent in the backpropagation process. Accordingly, a problem caused by gradient mismatch (or missing) in the binarized neural network, e.g., a dead weight problem, may be reduced, the binarized neural network may be efficiently trained with an improved or minimum decrease in accuracy, and the accuracy of the binarized neural network may be improved or enhanced as compared to a conventional scheme.

FIGS. 3 and 4 are block diagrams illustrating a binarized neural network training device according to example embodiments.

Referring to FIG. 3, a binarized neural network training device 100 includes a forward propagation process performing module 110 and a backpropagation process performing module 120.

Herein, the term “module” may indicate, but is not limited to, a software and/or hardware component, such as a field programmable gate array (FPGA) or an application specific integrated circuit (ASIC), which performs certain tasks. A module may be configured to reside in a tangible addressable storage medium and may be configured to execute on one or more processors. For example, a “module” may include components such as software components, object-oriented software components, class components and task components, and processes, functions, routines, segments of program code, drivers, firmware, microcode, circuitry, data, databases, data structures, tables, arrays, and variables. A “module” may be divided into a plurality of “modules” that perform detailed functions.

The forward propagation process performing module 110 may be configured to perform or execute a forward propagation process on a binarized neural network using a clipping function. For example, the forward propagation process performing module 110 may be configured to generate a binarized weight set by applying the clipping function to a weight set, and may be configured to generate output data by sequentially performing a forward computation on the binarized neural network based on input data and the binarized weight set. In other words, the forward propagation process performing module 110 may be configured to perform the operations of blocks S100 in FIG. 1 and blocks S110 and S130 in FIG. 2.

The backpropagation process performing module 120 may be configured to perform or execute a backpropagation process to update the weight set and to change a range of the clipping function. For example, the backpropagation process performing module 120 may be configured to generate a gradient of the weight set by sequentially performing a backward computation on the binarized neural network based on loss calculated from the output data, and may be configured to perform a training operation, which includes an operation of updating the weight set and an operation of changing the range of the clipping function, based on the gradient of the weight set. In other words, the backpropagation process performing module 120 may be configured to perform the operations of blocks S200 in FIG. 1 and blocks S210 and S230 in FIG. 2.

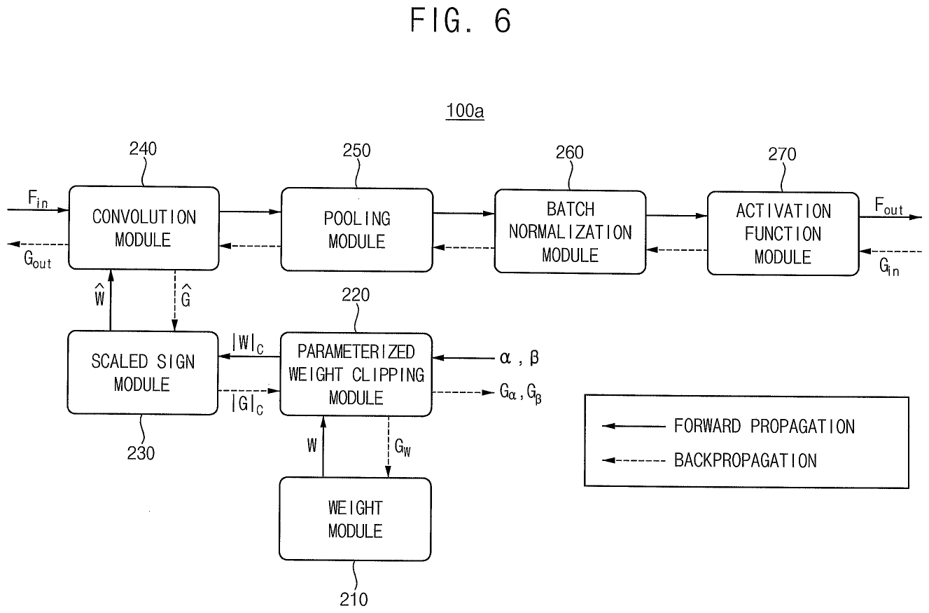

In some example embodiments, the forward propagation process performing module 110 and the backpropagation process performing module 120 may be implemented as a single integrated module. In other example embodiments, the forward propagation process performing module 110 and the backpropagation process performing module 120 may be implemented as separate and different modules. In some example embodiments, as will be described with reference to FIG. 6, the forward propagation process performing module 110 and the backpropagation process performing module 120 may be implemented to share some components.

At least some functionality of the forward propagation process performing module 110 and/or the backpropagation process performing module 120 may be implemented in software, which when stored in a memory is executable by a processor, but example embodiments are not limited thereto. When both the forward propagation process performing module 110 and the backpropagation process performing module 120 are implemented in software, the forward propagation process performing module 110 and the backpropagation process performing module 120 may be stored in the form of executable code in a storage device 1200.

Referring to FIG. 4, a binarized neural network training device 2000 includes a processor 2100, an input/output (I/O) device 2200, a network interface 2300, a random access memory (RAM) 2400, a read only memory (ROM) 2500 and a storage device 2600. FIG. 4 illustrates an example where both the forward propagation process performing module 110 and the backpropagation process performing module 120 in FIG. 3 are implemented in software.

The binarized neural network training device 2000 may be included in a computing system. For example, the computing system may be a fixed computing system such as a desktop computer, a workstation or a server, or may be a portable computing system such as a laptop computer.

The processor 2100 may be used by the forward propagation process performing module 110 and/or the backpropagation process performing module 120 in FIG. 3 to perform computations or calculations. For example, the processor 2100 may include a micro-processor, an application processor (AP), a central processing unit (CPU), a graphic processing unit (GPU), a neural processing unit (NPU), or the like. For example, the processor 2100 may include a core or a processor core for executing an arbitrary instruction set (for example, intel architecture-32 (IA-32), 64-bit extension IA-32, x86-64, PowerPC, Sparc, MIPS, ARM, IA-64, etc.). For example, the processor 2100 may access a memory (e.g., the RAM 2400 or the ROM 2500) through a bus, and may execute instructions stored in the RAM 2400 or the ROM 2500. As illustrated in FIG. 4, the RAM 2400 may store a program PR corresponding to the forward propagation process performing module 110 and/or the backpropagation process performing module 120 in FIG. 3 or at least some elements of the program PR, and the program PR may allow the processor 2100 to perform operations (e.g., blocks S100 and S200 in FIG. 1, and blocks S110, S130, S210 and S230 in FIG. 2) for training the binarized neural network.

In other words, the program PR may include a plurality of instructions and/or procedures executable by the processor 2100, and the plurality of instructions and/or procedures included in the program PR may allow the processor 2100 to perform the method of training the binarized neural network according to example embodiments. Each of the procedures may denote a series of instructions for performing a certain task. A procedure may be referred to as a function, a routine, a subroutine, or a subprogram. Each of the procedures may process data provided from the outside and/or data generated by another procedure.

In some example embodiments, the RAM 2400 may include a volatile memory such as a static random access memory (SRAM), a dynamic random access memory (DRAM), or the like.

The storage device 2600 may be configured to store the program PR. The program PR, or at least some elements of the program PR, may be loaded from the storage device 2600 to the RAM 2400 before being executed by the processor 2100. The storage device 2600 may be configured to store a file written in a program language, and the program PR, which may be generated by a compiler or the like, or at least some elements of the program PR, may be loaded to the RAM 2400.

The storage device 2600 may be configured to store data, which is to be processed by the processor 2100, or data obtained through processing by the processor 2100. The processor 2100 may be configured to process the data stored in the storage device 2600 to generate new data, based on the program PR and may be configured to store the generated data in the storage device 2600.

In some example embodiments, the storage device (or storage medium) 2600 may include any non-transitory computer-readable storage medium used to provide commands and/or data to a computer. For example, the non-transitory computer-readable storage medium may include a volatile memory such as an SRAM, a DRAM, or the like, and a nonvolatile memory such as a flash memory, a magnetic random access memory (MRAM), a phase-change random access memory (PRAM), a resistive random access memory (RRAM), or the like. The non-transitory computer-readable storage medium may be inserted into the computer, may be integrated in the computer, or may be coupled to the computer through a communication medium such as a network and/or a wireless link.

In some example embodiments, the storage device 2600 may be a solid state drive (SSD). In other example embodiments, the storage device 2600 may be a universal flash storage (UFS), a multi-media card (MMC) or an embedded multi-media card (eMMC). Alternatively, the storage device 2600 may be one of a secure digital (SD) card, a micro SD card, a memory stick, a chip card, a universal serial bus (USB) card, a smart card, a compact flash (CF) card, or the like.

The I/O device 2200 may include an input device, such as a keyboard, a pointing device, or the like, and may include an output device such as a display device, a printer, or the like. For example, a user may trigger, through the I/O devices 2200, execution of the program PR by the processor 2100 or may provide various inputs, and may check input data, output data, a result of training, and/or an error message, etc.

The network interface 2300 may provide access to a network outside the system 2000. For example, the network may include a plurality of computing systems and communication links, and the communication links may include wired links, optical links, wireless links, or arbitrary other type links. Various inputs may be provided to the system 2000 through the network interface 2300, and various outputs may be provided to another computing system through the network interface 2300.

FIGS. 5A, 5B and 5C are diagrams illustrating examples of a neural network model that is a target of a method of training a binarized neural network according to example embodiments.

Referring to FIG. 5A, a general neural network (or artificial neural network) may include an input layer IL, a plurality of hidden layers HL1, HL2, . . . , HLn and an output layer OL.

The input layer IL may include i input nodes x₁, x₂, . . . , x₁, where i is a natural number. Input data (e.g., vector input data) IDAT whose length is i may be input to the input nodes x₁, x₂, . . . , x₁ such that each element of the input data IDAT is input to a respective one of the input nodes x₁, x₂, . . . , xᵢ. The input data IDAT may include information associated with the various features of the different classes to be categorized.

The plurality of hidden layers HL1, HL2, . . . , HLn may include n hidden layers, where n is a natural number, and may include a plurality of hidden nodes h¹₁, h¹₂, h¹₃, . . . , h¹ₘ, h²₁, h²₂, h²₃, . . . , h²ₘ, hⁿ₁, hⁿ₂, hⁿ₃, . . . , hⁿₘ. For example, the hidden layer HL1 may include m hidden nodes h¹₁, h¹₂, h¹₃, . . . , h¹ₘ, the hidden layer HL2 may include m hidden nodes h²₁, h²₂, h²₃, . . . , h²ₘ, and the hidden layer HLn may include m hidden nodes hⁿ₁, hⁿ₂, hⁿ₃, . . . , hⁿₘ, where m is a natural number.

The output layer OL may include j output nodes y₁, y₂, . . . , yⱼ, where j is a natural number. Each of the output nodes y₁, y₂, . . . , yⱼ may correspond to a respective one of classes to be categorized. The output layer OL may generate output values (e.g., class scores or numerical output such as a regression variable) and/or output data ODAT associated with the input data IDAT for each of the classes. In some example embodiments, the output layer OL may be a fully-connected layer and may indicate, for example, a probability that the input data IDAT corresponds to a car.

A structure of the neural network illustrated in FIG. 5A may be represented by information on branches (or connections) between nodes illustrated as lines, and a weighted value assigned to each branch, which is not illustrated. In some neural network models, nodes within one layer may not be connected to one another, but nodes of different layers may be fully or partially connected to one another. In some other neural network models, such as unrestricted Boltzmann machines, at least some nodes within one layer may also be connected to other nodes within one layer in addition to (or alternatively with) one or more nodes of other layers.

Each node (e.g., the node WO may receive an output of a previous node (e.g., the node x₁), may perform a computing operation, computation or calculation on the received output, and may output a result of the computing operation, computation or calculation as an output to a next node (e.g., the node WO. Each node may calculate a value to be output by applying the input to a specific function, e.g., a nonlinear function. This function may be called the activation function for the node.

In some example embodiments, the structure of the neural network is set in advance, and the weighted values for the connections between the nodes are set appropriately by using sample data having sample answer (also referred to as a “label”), which indicates a class the data corresponding to a sample input value. The data with the sample answer may be referred to as “training data”, and a process of determining the weighted values may be referred to as “training”. The neural network “learns” to associate the data with corresponding labels during the training process. A group of an independently trainable neural network structure and the weighted values that have been trained using an algorithm may be referred to as a “model”, and a process of predicting, by the model with the determined weighted values, which class new input data belongs to, and then outputting the predicted value, may be referred to as a “testing” process or operating the neural network in inference mode.

Referring to FIG. 5B, an example of an operation (e.g., computation or calculation) performed by one node ND included in the neural network of FIG. 5A is illustrated in detail.

Based on N inputs a₁, a₂, a₃, . . . , a_{N} provided to the node ND, where N is a natural number greater than or equal to two, the node ND may multiply the N inputs a₁ to a_{N} and corresponding N weights w₁, w₂, w₃, . . . , w_{N}, respectively, may sum N values obtained by the multiplication, may add an offset “b” to a summed value, and may generate one output value (e.g., “z”) by applying a value to which the offset “b” is added to a specific function “σ”.

In some example embodiments and as illustrated in FIG. 5B, one layer included in the neural network illustrated in FIG. 5A may include M nodes ND, where M is a natural number greater than or equal to two, and output values of the one layer may be obtained by Equation 1.

W*A=Z [Equation 1]

In Equation 1, “W” denotes a weight set including weights for all connections included in the one layer, and may be implemented in an M*N matrix form. “A” denotes an input set including the N inputs a₁ to a_{N} received by the one layer, and may be implemented in an N*1 matrix form. “Z” denotes an output set including M outputs z₁, z₂, z₃, . . . , z_{M} output from the one layer, and may be implemented in an M*1 matrix form.

The general neural network illustrated in FIG. 5A may not be suitable for handling input image data (or input sound data) because each node (e.g., the node WO is connected to all nodes of a previous layer (e.g., the nodes x₁, x₂, . . . , xᵢ included in the layer IL) and then the number of weighted values drastically increases as the size of the input image data increases. Thus, a convolutional neural network (CNN), which is implemented by combining the filtering technique with the general neural network, has been researched such that a two-dimensional image, as an example of the input image data, is efficiently trained by the convolutional neural network.

Referring to FIG. 5C, a convolutional neural network may include a plurality of layers CONV1, RELU1, CONV2, RELU2, POOL1, CONV3, RELU3, CONV4, RELU4, POOL2, CONV5, RELU5, CONV6, RELU6, POOL3 and FC. Here, “CONV” denotes a convolutional layer, “RELU” denotes a rectified linear unit activation function, “POOL” denotes a pooling layer, and “FC” denotes a fully connected layer.

Unlike the general neural network, each layer of the convolutional neural network may have three dimensions of a width, a height and a depth, and thus data that is input to each layer may be volume data having three dimensions of a width, a height and a depth. For example, if an input image in FIG. 5C has a size of 32 widths (e.g., 32 pixels) and 32 heights and three color channels R, G and B, input data IDAT corresponding to the input image may have a size of 32*32*3. The input data IDAT in FIG. 5C may be referred to as input volume data or input activation volume.

Each of the convolutional layers CONV1, CONV2, CONV3, CONV4, CONV5 and CONV6 may perform a convolutional operation on input volume data. In an image processing operation, the convolutional operation represents an operation in which image data is processed based on a mask with weighted values and an output value is obtained by multiplying input values by the weighted values and adding up the total multiplication results. The mask may be referred to as a filter, a window, or a kernel.

Parameters of each convolutional layer may include a set of learnable filters. Every filter may be small spatially (along a width and a height), but may extend through the full depth of an input volume. For example, during the forward pass, each filter may be slid (e.g., convolved) across the width and height of the input volume, and dot products may be computed between the entries of the filter and the input at any position. As the filter is slid over the width and height of the input volume, a two-dimensional activation map corresponding to responses of that filter at every spatial position may be generated. As a result, an output volume may be generated by stacking these activation maps along the depth dimension. For example, if input volume data having a size of 32*32*3 passes through the convolutional layer CONV1 having four filters with zero-padding, output volume data of the convolutional layer CONV1 may have a size of 32*32*12 (e.g., a depth of volume data increases).

Each of the RELU layers RELU1, RELU2, RELU3, RELU4, RELU5 and RELU6 may perform a rectified linear unit (RELU) operation that corresponds to an activation function defined by, e.g., a function f(x)=max(0, x) (e.g., an output is zero for all negative input x). For example, if input volume data having a size of 32*32*12 passes through the RELU layer RELU1 to perform the rectified linear unit operation, output volume data of the RELU layer RELU1 may have a size of 32*32*12 (e.g., a size of volume data is maintained).

Each of the pooling layers POOL1, POOL2 and POOL3 may perform a down-sampling operation on input volume data along spatial dimensions of width and height. For example, four input values arranged in a 2*2 matrix formation may be converted into one output value based on a 2*2 filter. For example, a maximum value of four input values arranged in a 2*2 matrix formation may be selected based on 2*2 maximum pooling, or an average value of four input values arranged in a 2*2 matrix formation may be obtained based on 2*2 average pooling. For example, if input volume data having a size of 32*32*12 passes through the pooling layer POOL1 having a 2*2 filter, output volume data of the pooling layer POOL1 may have a size of 16*16*12 (e.g., a width and a height of volume data decreases, and a depth of volume data is maintained).

Typically, convolutional layers may be repeatedly arranged in the convolutional neural network, and the pooling layer may be periodically inserted in the convolutional neural network, thereby reducing a spatial size of an image and extracting a characteristic of the image.

The output layer or fully connected layer FC may output results (e.g., class scores) of the input volume data DAT for each of the classes. For example, the input volume data DAT corresponding to the two-dimensional image may be converted into a one-dimensional matrix or vector, which may be referred to as an embedding, as the convolutional operation and the down-sampling operation are repeated. For example, the fully connected layer FC may indicate probabilities that the input volume data IDAT corresponds to a car, a truck, an airplane, a ship and a horse.

The types and number of layers included in the convolutional neural network may not be limited to an example described with reference to FIG. 5C and may be variously determined according to example embodiments. In addition, although not illustrated in FIG. 5C, the convolutional neural network may further include other layers such as a softmax layer for converting score values corresponding to predicted results into probability values, a bias adding layer for adding at least one bias, or the like. The bias may also be incorporated into the activation function.

Hereinafter, example embodiments will be described based on the convolutional neural network, e.g., based on an example where the binarized neural network is a binarized convolutional neural network. However, example embodiments may not be limited thereto, and may be applied or employed to various other neural networks such as generative adversarial network (GAN), region with convolutional neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzman machine (RBM), fully convolutional network, long short-term memory (LSTM) Network. Alternatively or additionally, the neural network may include other forms of machine learning models, such as, for example, linear and/or logistic regression, statistical clustering, Bayesian classification, decision trees, dimensionality reduction such as principal component analysis, and expert systems; and/or combinations thereof, including ensembles such as random forests.

FIG. 6 is a block diagram illustrating an example of a binarized neural network training device for training a binarized convolutional neural network according to some example embodiments.

Referring to FIG. 6, a binarized neural network training device 100a may include a weight module 210, a parameterized weight clipping module 220, a scaled sign module 230, a convolution module 240, a pooling module 250, a batch normalization module 260 and an activation function module 270.

A binarized convolutional neural network trained by the binarized neural network training device 100a may be implemented by forming one layer group (or layer block) with layers that perform a convolution operation, a pooling operation, a batch normalization, an activation operation, etc., and by stacking (or connecting) several layer groups. In a training or inference process of the binarized convolutional neural network, a number of operations such as a convolution operation, a pooling operation, an activation operation and a fully connected layer operation may be required, and thus an operation of setting and updating a plurality of parameters for various operations may also be required. The modules 210 to 270 included in the binarized neural network training device 100a may be used to perform the above-described operations.

The modules 210 to 270 included in the binarized neural network training device 100a may be configured to perform a forward propagation process according to solid arrows, and may perform a backpropagation process according to dotted arrows.

Operations of the modules 210 to 270 in the forward propagation process illustrated by the solid arrows will be described as follows.

The weight module 210 may provide a weight set W including a plurality of weight elements. For example, a weight set that is most recently updated may be provided.

The parameterized weight clipping module 220 may be configured to receive the weight set W, may be configured to receive a first threshold value α and a second threshold value β that represent the clipping function, and may be configured to obtain a clipped weight set |W|_{c} by applying the clipping function to the plurality of weight elements included in the weight set W. For example, the first threshold value a and the second threshold value β that are most recently changed (or updated) may be received. For example, when the clipping function is applied to the weight set W, a weight element smaller than the first threshold value α among the plurality of weight elements included in the weight set W may be changed to the first threshold value α, and a weight element greater than the second threshold value β among the plurality of weight elements included in the weight set W may be changed to the second threshold value β.

In some example embodiments, each weight element may have a value in a range of (−1, +1) (e.g., a value greater than or equal to −1 and less than or equal to +1) by a weight initialization at an initial operation time, and thus an initial range of the clipping function may also be set to (−1, +1) such that all weight elements can be included within the range of the clipping function. In other words, initial values of the first threshold value a and the second threshold value β of the clipping function may be set to α=−1 and β=1. Thereafter, the clipping function may decrease from the initial range to a direction of decreasing the range, and the range of the clipping function may be changed for every training iteration to prevent a generation of dead weights.

The scaled sign module 230 may obtain a binarized weight set Ŵ by applying a scaled sign function to a plurality of clipped weight elements included in the clipped weight set |W|_{c}. For example, the binarized weight set Ŵ may include a plurality of binarized weight elements, and each of the plurality of binarized weight elements may be represented by a single bit, which may represent −1 or +1. For example, when the bit is 0 the binarized weight may be −1 and when the bit is 1 the binarized weight may be +1.

The convolution module 240 may be configured to perform a convolution operation on input data Fᵢₙ using the binarized weight set Ŵ. For example, when the convolution operation is performed, a value of the input data Fᵢₙ in a region overlapping the binarized weight set Ŵ that is in the form of a filter (e.g., kernel) may be multiplied with the binarized weight elements included in the binarized weight set Ŵ, the values obtained by the multiplications may be summed, and the value obtained by the summation may be obtained as one feature value to determine one point of a feature map. Such convolution operation may be repeatedly performed while the binarized weight set Ŵ that is in the form of the filter (or kernel) is sequentially shifted.

The pooling module 250 may be configured to perform a pooling operation on a result of the convolution operation output from the convolution module 240. For example, the pooling operation may represent a down-sampling (or sub-sampling) operation to reduce a size of the feature map. For example, an operation of selecting a maximum value in a corresponding region or generating an average value of the corresponding region may be performed while sliding a filter for down-sampling with a predetermined stride on the feature map.

The batch normalization module 260 may be configured to perform a batch normalization on a result of the pooling operation output from the pooling module 250. The batch normalization may represent an operation used to make training of neural networks faster and more stable through the normalization of inputs of layers by re-centering and re-scaling.

The activation function module 270 may be configured to obtain output data Fₒᵤₜ by applying an activation function to a result of the batch normalization output from the batch normalization module 260. For example, RELU, sigmoid, tan h, or the like, may be used as the activation function in accordance with different embodiments.

As described above, to train the binarized convolutional neural network, the binarized neural network training device 100a may perform the forward propagation process in which the output data Fₒᵤₜ is generated by performing the data processing on the input data Fᵢₙ.

In addition, subsequent to the forward propagation process, the binarized neural network training device 100a may perform the backpropagation process based on an error backpropagation algorithm for the backpropagation of an error on weights such that loss, which is a difference between the output data Fₒᵤₜ that is a result of the forward propagation process and a label that is an expected value, is reduced or minimized.

Operations of the modules 210 to 270 in the backpropagation process illustrated by the dotted arrows will be described as follows.

The activation function module 270 may be configured to reversely (or inversely) apply the activation function to loss input data Gᵢₙ calculated from the output data Fₒᵤₜ. An operation of reversely applying the activation function may represent that an inverse function of the activation function is applied and/or operations performed when the activation function is applied are performed in a reverse order.

The batch normalization module 260 may be configured to reversely perform the batch normalization on a result of reversely applying the activation function output from the activation function module 270.

The pooling module 250 may be configured to reversely perform the pooling operation on a result of reversely performing the batch normalization output from the batch normalization module 260.

The convolution module 240 may be configured to obtain loss output data Gₒᵤₜ and a gradient Ĝ of the binarized weight set Ŵ by reversely performing the convolution operation on a result of reversely performing the pooling operation output from the pooling module 250.

The scaled sign module 230 may be configured to obtain a gradient |G|_{c} of the clipped weight set |W|_{c} by reversely applying the scaled sign function to the gradient Ĝ of the binarized weight set Ŵ.

The parameterized weight clipping module 220 may be configured to obtain a gradient G_{W} of the weight set W, a gradient of the first threshold value α of the clipping function and a gradient of the second threshold value β of the clipping function by reversely applying the clipping function to the gradient |G|_{c} of the clipped weight set |W|_{c}. The gradient G_{W} of the weight set W may be provided to the weight module 210.

The weight set W, the first threshold value α of the clipping function, and the second threshold value β of the clipping function may be updated based on the gradient G_{W} of the weight set W, the gradient of the first threshold value α of the clipping function and the gradient of the second threshold value β of the clipping function, respectively, which will be described below. When performing gradient descent to train the binarized neural network, the gradient of the sign function is 0. As a result, the sign activation functions are ignored when doing backpropagation. In addition, the gradient updates are not performed on the binarized weights as this would cause the weights to no longer be either 1 or −1. The gradient updates are performed on the set of real-valued weights in the weight set W. The binarized network weights are then the binarization of these real-valued weights in the weight set W.

In the above-described backpropagation process, operations to find a desired or an optimal solution may be repeatedly performed based on a gradient descent scheme such that the error on weights (e.g., trained parameters) included in the binarized convolutional neural network is reduced or minimized. For example, each weight may converge to a predetermined real value by the training process. In the method of training the binarized neural network according to example embodiments, the gradient descent scheme, which has been applied only to weights, may also be applied to the clipping function, and thus the dead weight that inhibits the training process may be efficiently reduced.

The method of training the binarized neural network according to example embodiments may be implemented based on a straight through estimator (STE). The straight through estimator may represent a method to help a gradient approximation in the backpropagation process to overcome the zero gradient and gradient vanishing of a sign function. Therefore, to improve or enhance the accuracy of the binarized convolutional neural network, a gradient estimation function may be implemented or a binarization-friendly network architecture design may be implemented. Further, the gradient approximation using the straight through estimator and the parameterization of hyperparameters based thereon may be performed.

In the training or inference operation of the binarized convolutional neural network, the convolution operation may be performed by comparing inputs and weights with zero and by binarizing each of the inputs and the weights to +1 or −1 based on a result of the comparisons (e.g., based on sign information of each of the inputs and the weights). Therefore, the convolution operation, which accounts for most of the computations, may be performed as a bit operation in the binarized convolutional neural network, and thus the computational complexity may be drastically reduced.

In addition, in a general convolutional neural network, it may be required to more precisely update the weights to have the desired or optimal inference performance by repetitions of the above-mentioned forward propagation process and backpropagation process. In contrast, in the binarized convolutional neural network, the convolution operation may be performed after the binarization is applied based on the sign of the inputs and the weights, and thus the desired or optimal inference performance may be relatively easily and simply approached by appropriately determining the sign of the weights.

Further, when the neural network is trained, the weights may be updated in a decreasing direction, and thus the size of the loss may be reduced as the training process is continuously performed (e.g., as the forward propagation process and the backpropagation process are repeatedly performed). Moreover, when the learning rate is reduced in the training process of the neural network, the weights may be updated more precisely, so that the efficiency of the training process may be improved and the size of the loss may be reduced.

As described above, the forward propagation process may be performed by the modules 210 to 270, and thus the modules 210 to 270 may be included in the forward propagation process performing module 110 in FIG. 3. In addition, the backpropagation process may be performed by the modules 210 to 270, and thus the modules 210 to 270 may be included in the backpropagation process performing module 120 in FIG. 3. In other words, the modules 210 to 270 may be included in both the forward propagation process performing module 110 and the backpropagation process performing module 120, and the modules 210 to 270 may be shared by the forward propagation process performing module 110 and the backpropagation process performing module 120.

In some example embodiments, at least a part of the modules 210 to 270 may be implemented as hardware. For example, at least a part of the modules 210 to 270 may be included in a computer-based electronic system. In other example embodiments, at least a part of the modules 210 to 270 may be implemented as instruction code or program routines (e.g., a software program) that are executable by a processor when stored in a memory. For example, the instruction code or the program routines may be executed by a computer-based electronic system, and may be stored in any storage device located inside or outside the computer-based electronic system.

FIG. 7 is a flowchart illustrating an example of generating a binarized weight set in FIG. 2 according to some example embodiments.

Referring to FIGS. 2, 6 and 7, when generating the binarized weight set (block S110), the clipped weight set |W|_{c} may be obtained by applying the clipping function to the plurality of weight elements included in the weight set (step S111), and the binarized weight set Ŵ may be obtained by applying the scaled sign function to the plurality of clipped weight elements included in the clipped weight set |W|_{c} (block S113). For example, block S111 may be performed by the parameterized weight clipping module 220, and block S113 may be performed by the scaled sign module 230.

In the forward propagation process of the binarized neural network, the weight set W may be binarized based on Equation 2 and Equation 3, e.g., using the sign function. During the backpropagation process in the binarized neural network, Equation 4 may be applied as the straight through estimator for the sign function that is non-differentiable.

$$sign ( W ) = \{ \begin{matrix}+ 1 , & if W \geq 0 \\ - 1 , & otherwise\end{matrix} \qquad [ Equation 2 ]$$

$$\hat{W} = sign ( W ) \cdot \frac{1}{n} {\sum }_{n} \vert W \vert \qquad [ Equation 3 ]$$

$$clip ( - 1 , W , 1 ) = max ( - 1 , min ( W , 1 ) ) \qquad [ Equation 4 ]$$

Conventionally, the clipping function, may be used in the forward propagation process of the binarized neural network and performed prior to the binarization (e.g., before applying the scaled sign function), was implemented to have a fixed range of (−1, +1) as in Equation 4, so it was difficult to flexibly set the range of the clipping function. Such a conventional scheme in which the clipping function has a fixed range may be referred to as a constant weight clipping (CWC) scheme.

In contrast, in the method of training the binarized neural network according to example embodiments, the clipping function may be implemented to have a variable range of (α, β) as in Equation 5. For example, the range of the clipping function may be changed, adjusted, or controlled based on the gradient descent in the backpropagation process.

clip(α,W,β)=max(α,min(W,β)) [Equation 5]

FIG. 8 is a flowchart illustrating an example of generating output data in FIG. 2 according to some example embodiments.

Referring to FIGS. 2, 6 and 8, when generating the output data (block S130), the convolution operation may be performed on the input data Fᵢₙ using the binarized weight set Ŵ (block S131), the pooling operation may be performed on the result of the convolution operation (block S133), the batch normalization may be performed on the result of the pooling operation (block S135), and the output data Fₒᵤₜ may be obtained by applying the activation function to the result of the batch normalization (block S137). For example, block S131 may be performed by the convolution module 240, block S133 may be performed by the pooling module 250, block S135 may be performed by the batch normalization module 260, and block S137 may be performed by the activation function module 270.

FIG. 9 is a flowchart illustrating an example of generating a gradient of a weight set in FIG. 2 according to some example embodiments.

Referring to FIGS. 2, 6 and 9, when generating the gradient of the weight set (block S210), the activation function may be reversely applied to the loss input data Gᵢₙ calculated from the output data Fₒᵤₜ (block S211), the batch normalization may be reversely performed on the result of reversely applying the activation function (block S213), the pooling operation may be reversely performed on the result of reversely performing the batch normalization (block S215), the loss output data Gₒᵤₜ and the gradient Ĝ of the binarized weight set Ŵ may be obtained by reversely performing the convolution operation on the result of reversely performing the pooling operation (block S217), the gradient |G|_{c} of the clipped weight set |W|_{c} may be obtained by reversely applying the scaled sign function to the gradient Ĝ of the binarized weight set Ŵ (block S219), and the gradient G_{W} of the weight set W, a gradient G_{α} of the first threshold value α of the clipping function and a gradient G_{β} of the second threshold value β of the clipping function may be obtained by reversely applying the clipping function to the gradient |G|_{c} of the clipped weight set |W|_{c} (block S221). For example, block S211 may be performed by the activation function module 270, block S213 may be performed by the batch normalization module 260, block S215 may be performed by the pooling module 250, block S217 may be performed by the convolution module 240, block S219 may be performed by the scaled sign module 230, and block S221 may be performed by the parameterized weight clipping module 220.

When the conventional constant weight clipping scheme is used as in Equation 4 described above, the weight cannot exceed the fixed range of the clipping function. In a case in which the weight exceeds the fixed range of the clipping function, there is a problem in that an estimated value and an actual gradient function are inconsistent (which means the dead weight) and thus it may be difficult to accurately update the weight.

In the method of training the binarized neural network according to example embodiments, the parameterized weight clipping scheme capable of the gradient approximation with reduced or minimal overhead may be used, thereby reducing the dead weight that can occur in the constant weight clipping scheme. To implement a parameterized range of the clipping function according to a change of the weight, the gradient G_{W} of the weight set W, the gradient G_{α} of the first threshold value α of the clipping function and the gradient G_{β} of the second threshold value β of the clipping function may be defined as in Equation 6, Equation 7 and Equation 8, respectively.

$${G}_{W} = \frac{\partial ℒ}{\partial {\vert W \vert}_{c}} \frac{\partial {\vert W \vert}_{c}}{\partial W} , \\ \frac{\partial {\vert W \vert}_{c}}{\partial W} = \{ \begin{matrix}+ 1 , & if α < W < β \\ 0 , & otherwise\end{matrix} \qquad [ Equation 6 ]$$

$${G}_{α} = \frac{\partial ℒ}{\partial {\vert W \vert}_{c}} \frac{\partial {\vert W \vert}_{c}}{\partial α} , \\ \frac{\partial {\vert W \vert}_{c}}{\partial α} = \{ \begin{matrix}+ 1 , & if W < α & ( α < 0 ) \\ 0 , & otherwise & \end{matrix} \qquad [ Equation 7 ]$$

$${G}_{β} = \frac{\partial ℒ}{\partial {\vert W \vert}_{c}} \frac{\partial {\vert W \vert}_{c}}{\partial β} , \\ \frac{\partial {\vert W \vert}_{c}}{\partial β} = \{ \begin{matrix}+ 1 , & if W > β & ( β > 0 ) \\ 0 , & otherwise & \end{matrix} \qquad [ Equation 8 ]$$

[symbol] denotes a loss function, and

$$\frac{\partial ℒ}{\partial {\vert W \vert}_{c}}$$

denotes a gradient from a deep layer to the parameterized weight clipping module 220. Equation 6, Equation 7 and Equation 8 represent the gradient approximation for the clipping function, the first threshold value α and the second threshold value β, respectively. For example, in the clipping function of Equation 6, 1 may be returned if a given weight is in a range between the first threshold value α and the second threshold value β. Similarly, in Equation 7, ∂ [symbol] /∂α may return 1 if the given weight is less than the first threshold value α that is a negative threshold value. In Equation 8, ∂ [symbol] /∂β that is the gradient of the second threshold value β may be calculated using the straight through estimator to estimate

$$\frac{\partial ℒ}{\partial {\vert W \vert}_{c}}$$

as 1. As a result, the range of the clipping function may be flexibly adjusted according to the weight update with the gradient descent-based training.

FIG. 10 is a flowchart illustrating an example of performing a training operation in FIG. 2 according to some example embodiments.

Referring to FIGS. 2, 6 and 10, when performing the training operation (block S230), the weight set W may be updated based on the gradient G_{W} of the weight set W (block S231), the first threshold value α of the clipping function may be updated based on the gradient G_{α} of the first threshold value α of the clipping function (block S233), and the second threshold value β of the clipping function may be updated based on the gradient G_{β} of the second threshold value β of the clipping function (block S235). For example, blocks S231, S233 and S235 may be performed by the processor 2100 in FIG. 4.

The method of training the binarized neural network according to example embodiments may be implemented as in Table 1.

TABLE 1
Input: W, weigh set; |W|_{c}, clipped weight set; Ŵ, binarized weight set;
F′, the output of convolution e, the number of iterations; γₑ, learning rate;
α/β, parameterized clipping value;
Output: M_{b}Trained target BNN model

| | |
|---|---|
| 1: | procedure TRAINING |
| 2: | for e ← 0, iterations do |
| | (1) forward computation |
| 3: | Run forward computation of M |
| 4: | \|W\|_{c} = clip(α, W, β) |
| 5: | $\hat{W} = sign ( {\vert W \vert}_{c} ) \cdot \frac{1}{n} {\sum }_{n} \vert {\vert W \vert}_{c} \vert$ |
| 6: | Calculate F′ = Ŵ · [symbol] |
| | (2) backward and gradient computation |
| 8: | Compute distillation loss [symbol] _{KD} |
| 9: | Run backward and compute gradients |
| 10: | $Calculate \frac{\partial ℒ}{\partial \hat{W}} using \frac{\partial ℒ}{\partial {F}_{out}}$ |
| 11: | $Calculate \frac{\partial ℒ}{\partial {\vert W \vert}_{c}} using \frac{\partial ℒ}{\partial \hat{W}}$ |
| 12: | $Calculate \frac{\partial ℒ}{\partial W} using \frac{\partial ℒ}{\partial {\vert W \vert}_{c}}$ |
| 13: | $Calculate \frac{\partial ℒ}{\partial α} using \frac{\partial ℒ}{\partial {\vert W \vert}_{c}}$ |
| 14: | $Calculate \frac{\partial ℒ}{\partial β} using \frac{\partial ℒ}{\partial {\vert W \vert}_{c}}$ |
| 15: | ${W}_{e + 1} ← {W}_{e} - {γ}_{e} \frac{\partial ℒ}{\partial W} , {α}_{e + 1} ← {α}_{e} - {γ}_{e} \frac{\partial ℒ}{\partial α} , {β}_{e + 1} ← {β}_{e} - {γ}_{e} \frac{\partial ℒ}{\partial β}$ |
| 16: | end for |
| 17: | return trained binarized student model M_{b} |
| 18: | end procedure |

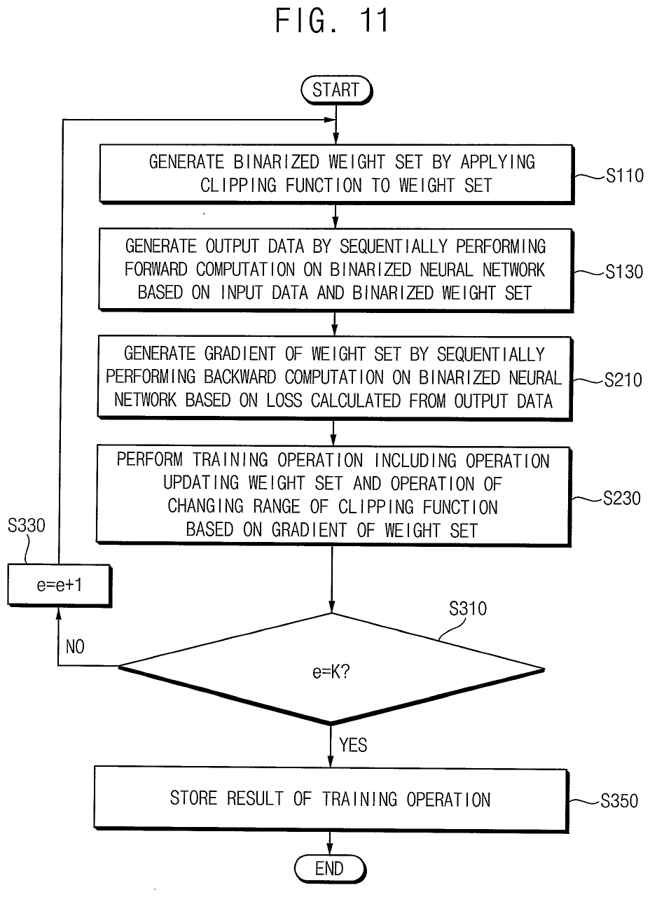

FIG. 11 is a flowchart illustrating an example of a method of training a binarized neural network of FIG. 1 according to some example embodiments. The descriptions of operations described previously with respect to FIG. 2 will be omitted.

Referring to FIGS. 1 and 11, blocks S110, S130, S210 and S230 may be substantially the same as those described with reference to FIG. 2.

Blocks S110, S130, S210 and S230 may be repeatedly performed by a number of iterations or repetitions (or by a reference number).

For example, when the number “e” of performing blocks S110, S130, S210 and S230 is different from the number of iterations “K” (blocks S310: NO), e.g., when the number “e” of performing blocks S110, S130, S210 and S230 is less than the number of iterations “K”, the number e may be increased by 1 (block S330), and blocks S110, S130, S210 and S230 may be re-performed.

When the number “e” of performing blocks S110, S130, S210 and S230 is equal to the number of iterations “K” (blocks S310: YES), e.g., after blocks S110, S130, S210 and S230 are repeatedly performed by the number of iterations “K”, a result of the training operation may be stored (blocks S350), and the process may be terminated.

In some example embodiments, the number of iterations “K” may be predetermined or preset to a specific value (e.g., 300 times) at the initial operation time. In other example embodiments, the number of iterations “K” may be determined or set such that blocks S110, S130, S210 and S230 are repeatedly performed until a predetermined condition (e.g., target accuracy or consistency) is satisfied. However, example embodiments may not be limited thereto, and the number of iterations K may be variously determined according to example embodiments.

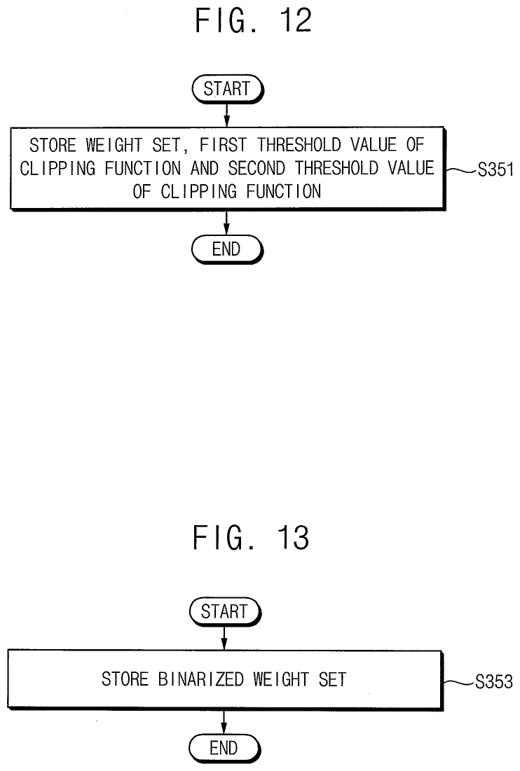

FIGS. 12 and 13 are flowcharts illustrating examples of storing a result of a training operation in FIG. 11 according to some example embodiments.

Referring to FIGS. 6, 11 and 12, when storing the result of the training operation (block S350), the weight set W, the first threshold value α of the clipping function and the second threshold value β of the clipping function, which are finally obtained by the lastly performed block S230, may be stored as the result of the training operation (block S351). In this example, when executing or operating the binarized neural network after training of the binarized neural network is complete (i.e., operating the binarized neural network in inference mode), the binarized weight set Ŵ may be calculated or generated based on the weight set W, the first threshold value α of the clipping function and the second threshold value β of the clipping function.

Referring to FIGS. 6, 11 and 13, when storing the result of the training operation (block S350), the binarized weight set Ŵ, which is calculated or generated based on the weight set W, the first threshold value α of the clipping function, and the second threshold value β of the clipping function that are finally obtained by the lastly performed block S230, may be stored as the result of the training operation (block S353). In this example, when executing or operating the binarized neural network after training of the binarized neural network is complete (i.e., operating the binarized neural network in inference mode), the operation of calculating the binarized weight set Ŵ may be skipped or omitted.

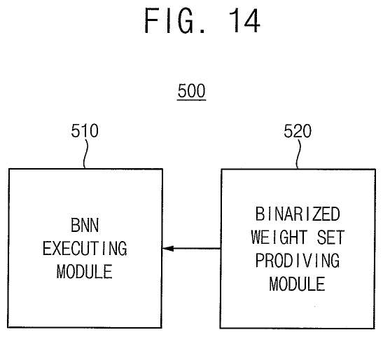

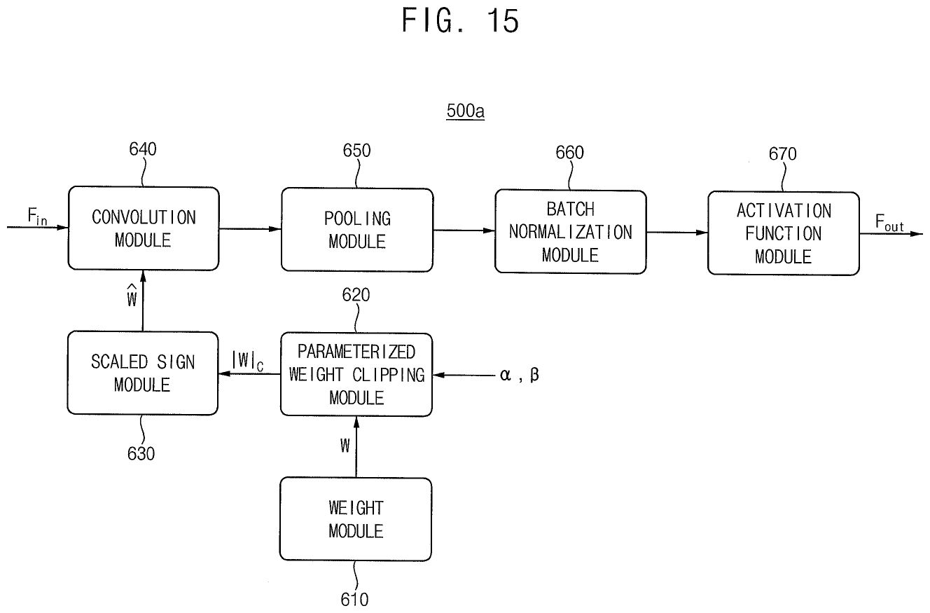

FIG. 14 is a block diagram illustrating a binarized neural network executing device according to example embodiments.

Referring to FIG. 14, a binarized neural network executing device 500 includes a binarized neural network executing module 510 and a binarized weight set providing module 520.

The binarized weight set providing module 520 may be configured to provide a binarized weight set (e.g., the binarized weight set Ŵ in FIG. 6) that is used when executing a binarized neural network in which a training operation is completed.

Using the binarized weight set that is provided from the binarized weight set providing module 520, the binarized neural network executing module 510 may be configured to execute the binarized neural network in which the training operation is completed, i.e., operate the binarized neural network in inference mode. For example, binarized neural network executing module 510 may perform an inference on input data.

The operations of the binarized weight set providing module 520 and the binarized neural network executing module 510 may be similar to that of the forward propagation process performing module 110 in FIG. 3, e.g., may be similar to the forward propagation process.

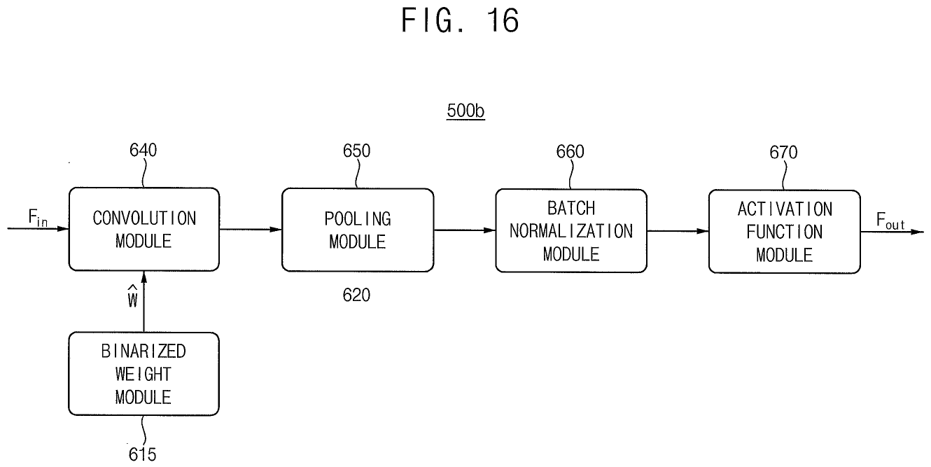

FIGS. 15 and 16 are block diagrams illustrating examples of a binarized neural network executing device that that is configured to execute a binarized convolutional neural network according to some example embodiments.

Referring to FIG. 15, a binarized neural network executing device 500a may include a weight module 610, a parameterized weight clipping module 620, a scaled sign module 630, a convolution module 640, a pooling module 650, a batch normalization module 660 and an activation function module 670.

The weight module 610, the parameterized weight clipping module 620, the scaled sign module 630, the convolution module 640, the pooling module 650, the batch normalization module 660 and the activation function module 670 may be similar to the weight module 210, the parameterized weight clipping module 220, the scaled sign module 230, the convolution module 240, the pooling module 250, the batch normalization module 260 and the activation function module 270 in FIG. 6, respectively. In an example of FIG. 15, the backpropagation process may not be performed because the binarized neural network in which the training operation is completed may be executed, and thus the weight set W, the first threshold value α of the clipping function and the second threshold value β of the clipping function may be fixed or maintained without being changed or updated.

Referring to FIG. 16, a binarized neural network executing device 500b may include a binarized weight module 615, a convolution module 640, a pooling module 650, a batch normalization module 660 and an activation function module 670.

The binarized neural network executing device 500b may be substantially the same as the binarized neural network executing device 500a of FIG. 15, except that the weight module 610 is replaced with the binarized weight module 615 and the parameterized weight clipping module 620 and the scaled sign module 630 are omitted.

The binarized neural network executing device 500a of FIG. 15 may be implemented by performing block S351 in FIG. 12, and the binarized neural network executing device 500b of FIG. 16 may be implemented by performing block S353 in FIG. 13.

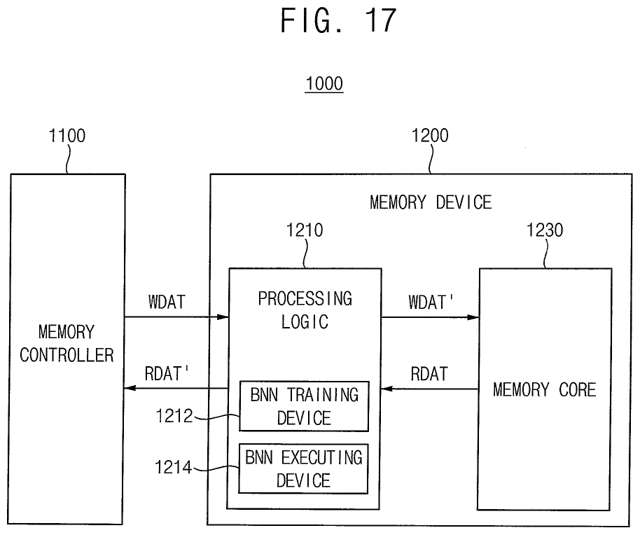

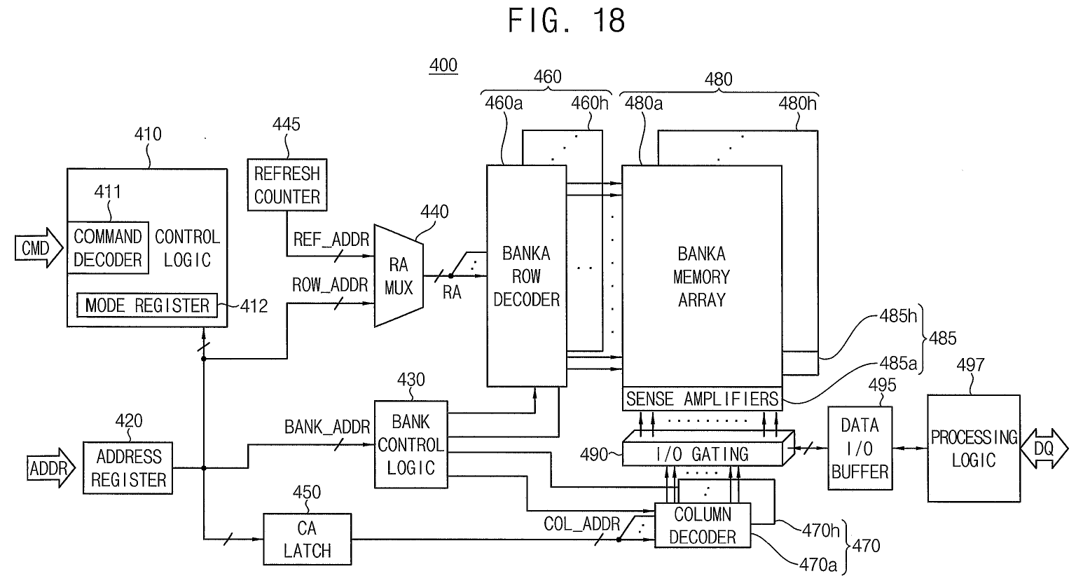

FIG. 17 is a block diagram illustrating a memory device and a memory system including the memory device according to example embodiments.

Referring to FIG. 17, a memory system 1000 includes a memory controller 1100 and a memory device 1200.

The memory controller 1100 may be configured to control an operation of the memory system 1000. For example, the memory controller 1100 may be configured to control data write and/or read operations of the memory device 1200.

The memory device 1200 may be configured to store a plurality of data. The memory device 1200 includes a processing logic 1210 and a memory core 1230.

The memory core 1230 includes a plurality of memory cells that store the plurality of data.

The processing logic 1210 is disposed or located between the memory controller 1100 and the memory core 1230, and may be configured to perform operations, processing, treatment, etc. associated with or related to an operation of the memory device 1200. As the processing logic 1210 is included in the memory device 1200, the memory device 1200 may be implemented as a processing-in-memory (PIM) device.

The processing logic 1210 may be configured to train and execute or operate a binarized neural network. The processing logic 1210 may include a binarized neural network training device 1212 and a binarized neural network executing device 1214.

The binarized neural network training device 1212 may be the binarized neural network training device according to example embodiments, and may be configured to perform the method of training the binarized neural network according to example embodiments. In other words, in an example of FIG. 17, the binarized neural network may be trained using the memory device 1200 and the processing logic 1210.

The binarized neural network executing device 1214 may be the binarized neural network executing or operating device according to example embodiments. For example, the binarized neural network executing device 1214 may be configured to execute or operate the binarized neural network, and thus the processing logic 1210 may be configured to perform data processing on write data WDAT to be stored into the memory core 1230 or read data RDAT retrieved from the memory core 1230, using the binarized neural network. For example, during the data write operation, the memory controller 1100 may be configured to transmit the write data WDAT, the processing logic 1210 may be configured to perform an inference on the write data WDAT by executing the binarized neural network, and output data WDAT′ representing a result of the inference may be stored into the memory core 1230. For example, during the data read operation, the read data RDAT may be retrieved from the memory core 1230, the processing logic 1210 may be configured to perform an inference on the read data RDAT by executing the binarized neural network, and output data RDAT′ representing a result of the inference may be transmitted to the memory controller 1100.

In some example embodiments, the binarized neural network executing device 1214 may be implemented as illustrated in FIG. 15. In this example, the weight set W, the first threshold value α of the clipping function and the second threshold value β of the clipping function that are stored as the result of the training operation may be loaded or stored, the binarized weight set Ŵ may be generated based on the loaded weight set W, the loaded or stored first threshold value α of the clipping function and the loaded or stored second threshold value β of the clipping function, and the binarized neural network is executed or operated using the generated binarized weight set Ŵ.

In other example embodiments, the binarized neural network executing device 1214 may be implemented as illustrated in FIG. 16. In this example, the binarized weight set Ŵ that is stored as the result of the training operation may be loaded, and the binarized neural network may be executed using the loaded binarized weight set Ŵ.

In some example embodiments, as with those described with reference to FIGS. 6, 15 and 16, some components included in the binarized neural network training device 1212 and the binarized neural network executing device 1214 may be substantially the same as or similar to each other, and thus some components may be shared by the binarized neural network training device 1212 and the binarized neural network executing device 1214.

FIG. 18 is a block diagram illustrating an example of a memory device in FIG. 17 according to some example embodiments.

Referring to FIG. 18, a memory device 400 may include a control logic 410, an address register 420, a bank control logic 430, a row address multiplexer 440, a refresh counter 445, a column address latch 450, a row decoder 460, a column decoder 470, a memory cell array 480, a sense amplifier unit 485, an input/output (I/O) gating circuit 490, a data input/output buffer 495 and a processing logic 497.

The memory cell array 480 may correspond to the memory core 1230 in FIG. 17, the processing logic 497 may correspond to the processing logic 1210 in FIG. 17, and remaining components may form a control circuit or peripheral circuit for controlling an operation of the memory core 1230. FIG. 18 illustrates an example where the memory device 400 is a DRAM, but example embodiments may not be limited thereto.

The memory cell array 480 may include a plurality of bank arrays 480a to 480h. The row decoder 460 may include a plurality of bank row decoders 460a to 460h respectively coupled to the bank arrays 480a to 480h, the column decoder 470 may include a plurality of bank column decoders 470a to 470h respectively coupled to the bank arrays 480a to 480h, and the sense amplifier unit 485 may include a plurality of bank sense amplifiers 485a to 485h respectively coupled to the bank arrays 480a to 480h.

The address register 420 may be configured to receive an address ADDR including a bank address BANK_ADDR, a row address ROW_ADDR and a column address COL_ADDR from an external processor or an external memory controller. The address register 420 may be configured to provide the received bank address BANK_ADDR to the bank control logic 430, may be configured to provide the received row address ROW_ADDR to the row address multiplexer 440, and may be configured to provide the received column address COL_ADDR to the column address latch 450.

The bank control logic 430 may be configured to generate bank control signals in response to the bank address BANK_ADDR. One of the bank row decoders 460a to 460h corresponding to the bank address BANK_ADDR may be activated in response to the bank control signals, and one of the bank column decoders 470a to 470h corresponding to the bank address BANK_ADDR may be activated in response to the bank control signals.

The row address multiplexer 440 may be configured to receive the row address ROW_ADDR from the address register 420, and may be configured to receive a refresh row address REF_ADDR from the refresh counter 445. The row address multiplexer 440 may be configured to selectively output the row address ROW_ADDR or the refresh row address REF_ADDR as a row address RA. The row address RA that is output from the row address multiplexer 440 may be applied to the bank row decoders 460a to 460h.

The activated one of the bank row decoders 460a to 460h may be configured to decode the row address RA that is output from the row address multiplexer 440, and may activate a wordline corresponding to the row address RA. For example, the activated bank row decoder may be configured to apply a wordline driving voltage to the wordline corresponding to the row address RA.

The column address latch 450 may be configured to receive the column address COL_ADDR from the address register 420, and may temporarily store the received column address COL_ADDR. In some example embodiments, in a burst mode, the column address latch 450 may be configured to generate column addresses that increment from the received column address COL_ADDR. The column address latch 450 may be configured to apply the temporarily stored or generated column address to the bank column decoders 470a to 470h.

The activated one of the bank column decoders 470a to 470h may be configured to decode the column address COL_ADDR that is output from the column address latch 450, and may be configured to control the input/output gating circuit 490 to output data corresponding to the column address COL_ADDR.

The input/output gating circuit 490 may include circuitry for gating input/output data. The input/output gating circuit 490 may further include read data latches for storing data that is output from the bank arrays 480a to 480h, and write drivers for writing data to the bank arrays 480a to 480h.

Data to be read from one bank array of the bank arrays 480a to 480h may be sensed by a sense amplifier 485 coupled to the one bank array from which the data is to be read, and may be stored in the read data latches. The data stored in the read data latches may be provided to the processor or the memory controller via the data input/output buffer 495. Data DQ to be written in one bank array of the bank arrays 480a to 480h may be provided to the data input/output buffer 495 from the processor or the memory controller. The write driver may be configured to write the data DQ in one bank array of the bank arrays 480a to 480h.

The control logic 410 may be configured to control operations of the memory device 400. For example, the control logic 410 may be configured to generate control signals for the memory device 400 to perform a write operation or a read operation. The control logic 410 may include a command decoder 411 that decodes a command CMD received from the memory controller and a mode register set 412 that sets an operation mode of the memory device 400. For example, the command decoder 411 may be configured to generate the control signals corresponding to the command CMD by decoding a write enable signal, a row address strobe signal, a column address strobe signal, a chip selection signal, etc.

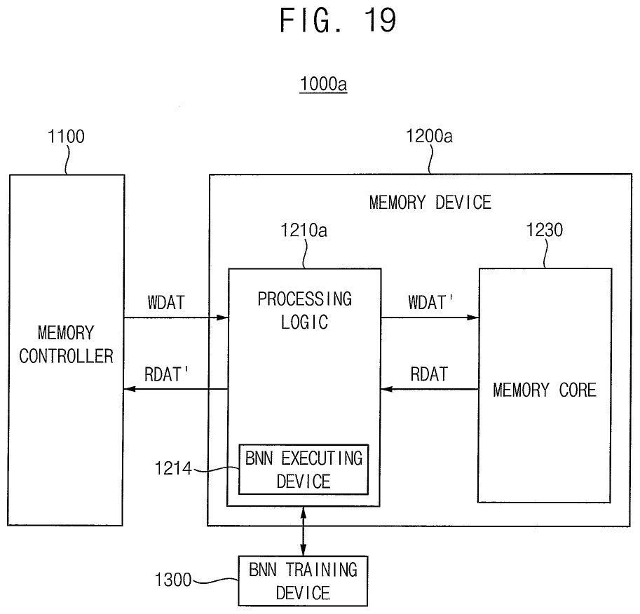

FIG. 19 is a block diagram illustrating a memory device and a memory system including the memory device according to example embodiments. The descriptions of operations or elements described previously with respect to FIG. 17 will be omitted.

Referring to FIG. 19, a memory system 1000a includes a memory controller 1100, a memory device 1200 and a binarized neural network training device 1300. The memory device 1200a includes a processing logic 1210a and a memory core 1230. The processing logic 1210a may include a binarized neural network executing device 1214.

The memory system 1000a may be substantially the same as the memory system of FIG. 17, except that the binarized neural network training device 1300 is located outside the memory device 1200a. In the example of FIG. 19, the binarized neural network may be trained by using the external binarized neural network training device 1300.

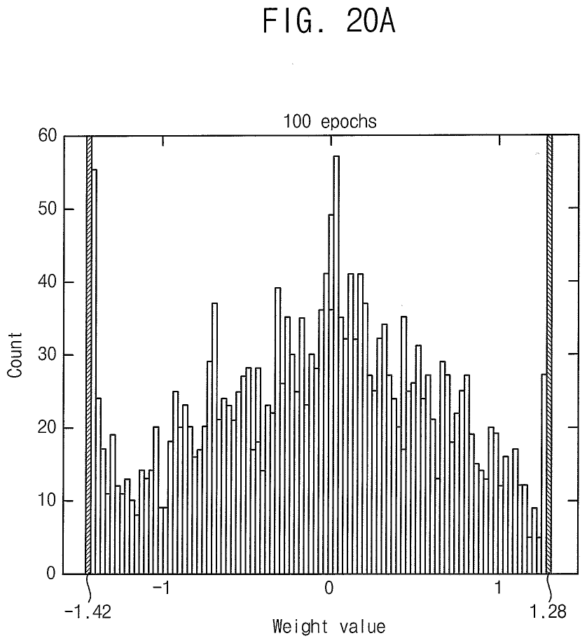

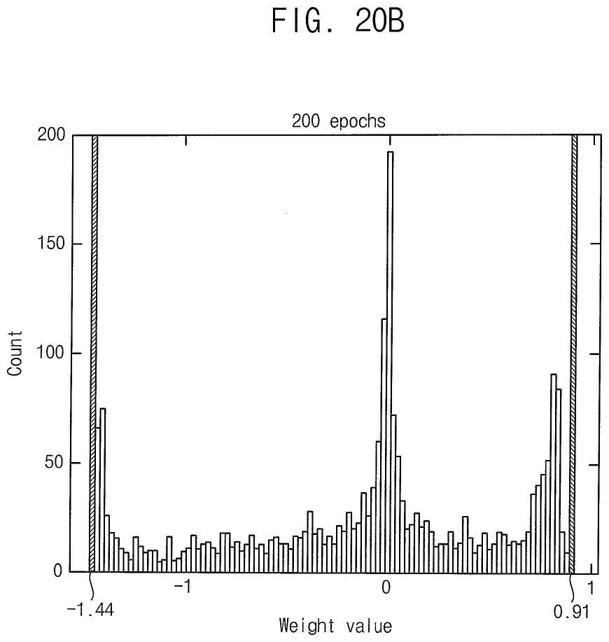

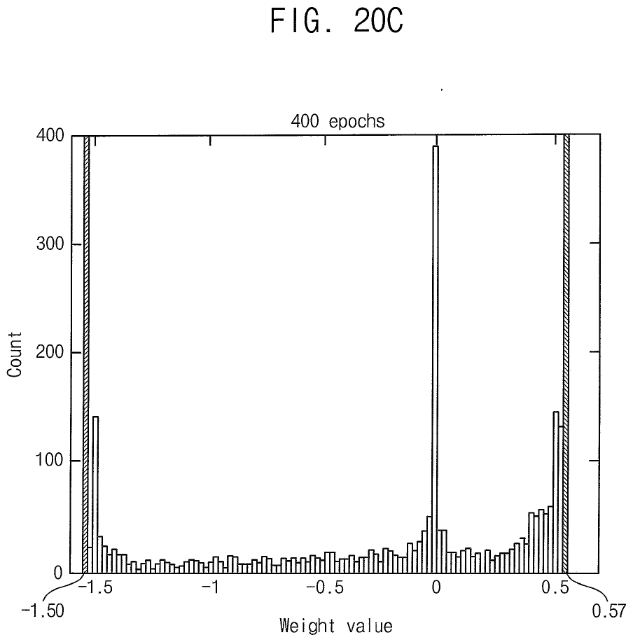

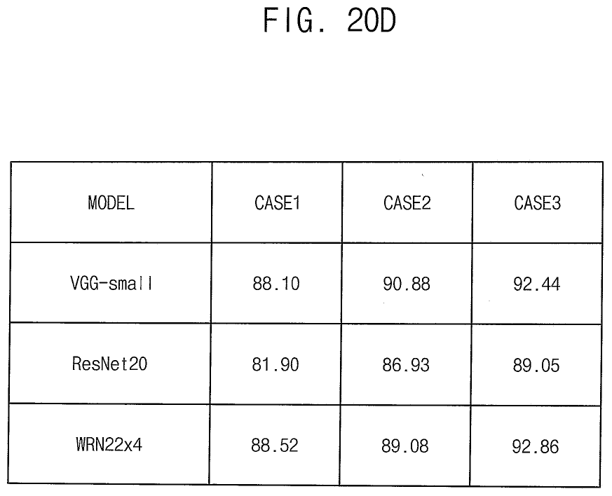

FIGS. 20A, 20B, 20C and 20D are diagrams for describing performance of a method of training a binarized neural network according to example embodiments.

Referring to FIGS. 20A, 20B and 20C, the change in the range of the clipping function is illustrated when the forward propagation process and the backpropagation process are repeated 100 times (FIG. 20A), 200 times (FIG. 20B) and 300 times (FIG. 20C).

Referring to FIG. 20D, CASE1, CASE2 and CASE3 represent the no weight clipping (NWC) scheme, the constant weight clipping (CWC) scheme, and the parameterized weight clipping (PWC) scheme, respectively. FIG. 20D illustrates the training results (e.g., accuracy) for various neural network models. It can be seen that the accuracy is improved or enhanced when the parameterized weight clipping scheme is applied according to example embodiments.

The inventive concept may be applied to various electronic devices and systems in which the neural networks are used, applied, and/or employed. For example, the inventive concept may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of training a binarized neural network (BNN), the method comprising:
generating a binarized weight set by applying a clipping function to a weight set;
generating output data by sequentially performing a forward computation on the binarized neural network based on input data and the binarized weight set;
generating a gradient of the weight set by sequentially performing a backward computation on the binarized neural network based on loss calculated from the output data; and
training the binarized neural network, comprising:
updating the weight set based on the gradient of the weight set; and
changing a range of the clipping function.

2. The method of claim 1, wherein the range of the clipping function is adaptively changed based on a magnitude of the weight set.

3. The method of claim 1, wherein the clipping function includes a first threshold value and a second threshold value, and
wherein changing the range of the clipping function comprises using a gradient of the first threshold value of the clipping function and a gradient of the second threshold value of the clipping function.

4. The method of claim 1, wherein changing the range of the clipping function comprises changing at least one of a first threshold value and a second threshold value of the clipping function.

5. The method of claim 1, wherein generating the binarized weight set comprises:
obtaining a clipped weight set by applying the clipping function to a plurality of weight elements included in the weight set; and
obtaining the binarized weight set by applying a scaled sign function to a plurality of clipped weight elements included in the clipped weight set.

6. The method of claim 1, wherein generating the output data comprises:
performing a convolution operation on the input data using the binarized weight set;
performing a pooling operation on a result of the convolution operation;
performing a batch normalization on a result of the pooling operation; and
obtaining the output data by applying an activation function to a result of the batch normalization.

7. The method of claim 1, wherein generating the gradient of the weight set comprises:
reversely applying an activation function to loss input data calculated from the output data;
reversely performing a batch normalization on a result of reversely applying the activation function;
reversely performing a pooling operation on a result of reversely performing the batch normalization;
obtaining loss output data and a gradient of the binarized weight set by reversely performing a convolution operation on a result of reversely performing the pooling operation;
obtaining a gradient of a clipped weight set by reversely applying a scaled sign function to the gradient of the binarized weight set; and
obtaining the gradient of the weight set, a gradient of a first threshold value of the clipping function, and a gradient of a second threshold value of the clipping function by reversely applying the clipping function to the gradient of the clipped weight set.

8. The method of claim 1, updating the weight set comprises:
updating the weight set by subtracting the gradient from the weight set; and
wherein changing the range of the clipping function comprises:
updating a first threshold value of the clipping function based on a gradient of the first threshold value of the clipping function; and
updating a second threshold value of the clipping function based on a gradient of the second threshold value of the clipping function.

9. The method of claim 1, further comprising:
iteratively performing the operations of generating the binarized weight set, generating the output data, generating the gradient of the weight set, updating the weight set, and changing the range of the clipping function.

10. The method of claim 9, further comprising:
storing a result of the training operation after iteratively performing the operations of generating the binarized weight set, generating the output data, generating the gradient of the weight set, updating the weight set, and changing the range of the clipping function a predetermined number of iterations.

11. The method of claim 10, wherein storing the result of the training operation comprises:
storing the weight set, a first threshold value of the clipping function and a second threshold value of the clipping function.

12. The method of claim 10, wherein storing the result of the training operation comprises:
storing the binarized weight set.

13. The method of claim 1, wherein the binarized neural network is a binarized convolutional neural network (BCNN).

14. The method of claim 13, wherein the binarized convolutional neural network includes a plurality of convolutional layers, and
wherein the operations of generating the binarized weight set, generating the output data, generating the gradient of the weight set, updating the weight set, and changing the range of the clipping function are performed on at least one of remaining convolutional layers other than a first convolutional layer among the plurality of convolutional layers.

15. The method of claim 13, wherein the binarized convolutional neural network includes a plurality of layers,
wherein the plurality of layers include at least one fully connected layer, and
wherein the operations of generating the binarized weight set, generating the output data, generating the gradient of the weight set, updating the weight set, and changing the range of the clipping function are performed on at least one of remaining layers other than the fully connected layer among the plurality of layers.

16. A memory device comprising:
processing logic; and
a memory core including a plurality of memory cells and comprising data embodied in the memory cells that is executable by the processing logic to perform operations comprising:
generating a binarized weight set by applying a clipping function to a weight set;
generating output data by sequentially performing a forward computation on the binarized neural network based on input data and the binarized weight set;
generating a gradient of the weight set by sequentially performing a backward computation on the binarized neural network based on loss calculated from the output data; and
training a binarized neural network (BNN), comprising:
updating the weight set based on the gradient of the weight set; and
changing a range of the clipping function.

17. The memory device of claim 16, wherein the operations further comprise:
storing the weight set, a first threshold value of the clipping function, and a second threshold value of the clipping function as a result of training the binarized neural network;
generating the binarized weight set based on the stored weight set, the stored first threshold value of the clipping function, and the stored second threshold value of the clipping function; and
operating the binarized neural network in inference mode using the generated binarized weight set.

18. The memory device of claim 16, wherein the operations further comprise:
storing the binarized weight set as a result of training the binarized neural network; and
operating the binarized neural network in inference mode using the stored binarized weight set.

19. The memory device of claim 16, wherein the binarized neural network is trained using the memory device or a binarized neural network training device located outside the memory device.

20. A method of training a binarized neural network (BNN), the method comprising:
obtaining a clipped weight set by applying a clipping function to a weight set;
obtaining a binarized weight set by applying a scaled sign function to the clipped weight set;
generating output data by sequentially performing a forward computation on the binarized neural network based on input data and the binarized weight set;
generating a gradient of the weight set, a gradient of a first threshold value of the clipping function, and a gradient of a second threshold value of the clipping function by sequentially performing a backward computation on the binarized neural network based on loss calculated from the output data;
updating the weight set based on the gradient of the weight set;
updating the first threshold value of the clipping function based on the gradient of the first threshold value of the clipping function; and
updating the second threshold value of the clipping function based on the gradient of the second threshold value of the clipping function,
wherein:
the binarized neural network is a binarized convolutional neural network (BCNN),
the forward computation is performed in an order of a convolution operation, a pooling operation, a batch normalization, and an activation function,
the backward computation is performed in an order of the activation function, the batch normalization, the pooling operation, the convolution operation, the scaled sign function, and the clipping function,
a range of the clipping function is adaptively changed based on a magnitude of the weight set, and
the range of the clipping function is changed using the gradient of the first threshold value of the clipping function and the gradient of the second threshold value of the clipping function.
